(19) United States
(12) Patent Application Publication
(10) Pub. No.: US 2012/0044319 A1
(43) Pub. Date: Feb. 23, 2012

(54) Videochat Game

(76) Inventor: Scott Thompson, Hatfield, PA (US)

(21) Appl. No.: 12/858,529

(22) Filed: Aug. 18, 2010

(51) Int. Cl. H04N 7/15

(52) U.S. Cl. 348/14.07; 348/E07.083

(57) ABSTRACT

This patent turns a basic videoconference system into web-based games through:

The incorporation of the visual and/or audio stimuli of videoconference attendees

Manipulation of each players' displayed streaming image's sizes, shape, color, and location

A programmed sequence of events

Manipulation of camera effects

Displayed text-based data

Background geometric shapes and/or colors and/or patterns.

Videoconference systems are nothing new. Similarly, video games delivered through videoconference systems are also nothing new. A variety of websites offer both videoconference systems and games that work together to provide communication during game play. A typical game might be something like on-line “Checkers” where an on-screen checker board is shared between two players, and each player reacts to their competitor's on-screen board moves. In this case, the required visual action is focused on the checkerboard and game pieces, not the players themselves. The game would continue to function regardless if the visual and audio stimuli of the players were removed. I.e. The videoconference system is secondary—it is separate from game function.

And that is where this patent differs. This patent turns the basic videoconference system into a game. The basic video and/or audio aspect of the videoconference system become critical components of game play. Removal of a player's image or audio stimuli ceases game function. This critical visual and audio perspective, combined with new ways of manipulating both the streaming images of players, and virtual videoconference rooms, come together to create a new kind of game.

This patent's system is created through a marriage of the following 5 components:

1. Through direct player visual stimuli (live streaming feed),

2. Through direct player audible stimuli

3. Through text-based feedback

4. Through sequenced manipulation of the size, and/or the positioning, and/or the coloring of a singular or plurality of players' on-screen streaming images and the frame(s) that surrounds their image(s).

5. Through manipulation of varied colorful geometric background patterns, shapes, and colors that are used to group players together into teams and/or reveal potential turns in a turn-based game,

An example of [0003]#1 above can be found in an on-line version of the game “Charades.” Charades requires direct visual stimuli from one player to another as one player acts out a topic for a second player (or more) to guess. Without this visual aspect of the acting player, the game ceases to function.

An example of [0003]#2 above can also be found in an on-line version of the game “Charades.” Charades requires direct auditory stimuli feedback from a player or players that are trying to guess what the acting player is trying to portray. Without this auditory response aspect of the guessing players, the game ceases to function.

An example of [0003]#3 above can also be found in an on-line version of the game “Charades.” Charades requires feedback from a player or players that are trying to guess what the acting player is trying to portray. A form of feedback that could be used might be typing text into the game.

An example of [0003]#4 above can also be found in an on-line version of the game “Charades.” A virtual videochat room could be set up with 2 competing teams, 1 Red and 1 Blue (Colors). The images of the players would move around the screen according to a set sequence (player image motion). An example of this might be to move a player from the side of the screen and feature them in the center of the screen. This motion could also be accompanied by a change of size. An example would be that the featured player in the center of the screen is enlarged so that other players can see the featured player's actions better. Additionally, the frame around a player's streaming image might flash a different color when they succeed or fail at moving a game forward.

An example of [0003]#5 above can also be found in an on-line version of the game “Charades.” Should a team win the game, their image might zoom in and out as they flaunt their win. This might create an effect that embodies the word “gloat.” Players would get to rub their win in the loser's face.

An example of [0003]#1 above can also be found in an on-line version of the game “Charades.” Teams are created and grouped together by colorful backgrounds. These colors allow for instant differentiation between teams, help display in a graphic way which player or team's turn it is, and help personalize the game in player communications.

These examples are not meant to limit the scope of this patent, but rather to portray an understanding of the components that build to create the concept.

### DESCRIPTION OF DRAWING FIGURES

FIG. 1: Shows an example of a newly opened Video Chat Game Room

FIG. 2: Shows Game play

### DETAILED DESCRIPTION OF DRAWING FIGURES

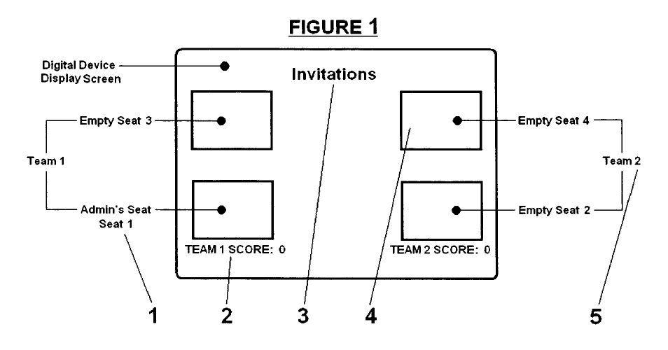

FIG. 1: Shows an example of a newly opened Video Chat Game Room. This is the appearance of an example game room on a digital device display screen when opened by the initial player (The Admin).

1. The admin sits in Player Seat 1. The room admin has responsibility for starting and overseeing game play, sending out invitations, selecting to make the room public or private, choosing the game type for the room, making sure that players understand the game, and ejecting unruly players.

2. Game Score: Score keep track of who is winning or losing the game

3. Invitations: An invitation system is set up to invite players to attend the game through a link sent via digital forms of communication such as email, text, beep, etc.

4. Empty Seats: These reserved screen positions wait for players to join the room and click on an empty seat. Once clicked, the player's computer is connected to the server and their live image is streamed into the room for all to see, and their web audio is connected so all players can hear each other.

5. Teams: this room is set up with players able to choose between 2 teams that they can join—Team 1 or Team 2. Teams can also be organized by colors such as Red Team and Blue Team through displayed colors around players, as colored player windows, or us backgrounds. Shapes could also be used to show team affiliation such as Triangle Team and Circle Team.

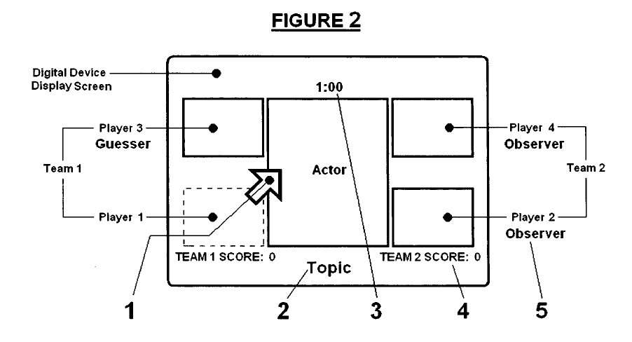

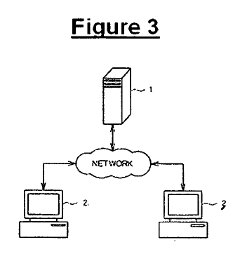

FIG. 2: Shows Game Play

The game starts when the admin clicks a start game button. In this game example (Charades), all the seats must be filled so that there are two players on each team. This allows one player to act and one player to guess the actors topic. The live streaming images of players are moved about the display screen according to game play and need. As displayed in this example, player to player communication is critical to moving the game forward. It is in fact, part of the game.

1. In this game example, the Admin is sitting in seat one, making him Player 1. Player 1 goes first. Player 1's live streaming image slides out to the center of the display and increases in size so all other players have a better view of this player. This player, now prominently featured in the center is the ACTOR, and Player 3 (The TEAMMATE) is the guesser.

2. On all screens but the Guesser's display screen, a topic is shown that the Actor must act out. This topic could be on any topic of interest. Visual and Audio feedback flows back and forth between actor and guesser as they attempt to communicate the topic. The Guesser makes guesses based on the actors silent actions. The actor moves the guesser closer and closer to guessing the topic based on visual and audio feedback. Should the guesser guess the topic, the Actor clicks his display screen. This click tells the system that the correct answer has been given and to award a point to the team.

3. The Clock: When the topic is displayed, a clock starts to tick and counts down a set time amount. If the Guesser can guess the Actor's topic within that time limit, a point is awarded. The game can continue for an number of rounds, and the winner is the team that has the highest total points at the end of the game.

4. Game Score: This is the on-screen display that allows game players the ability to tell who is winning and who is losing.

5. The opposing team (Team 2) can watch the actor and guesser struggle to communicate. But their role is “Observer” during the other team's turn.

Game play continues as each player has a turn in the center acting position of the display screen. Each completion of all players having a chance to act and guess is called a round. And any number of rounds can be completed to complete the game.

FIG. 3: Standard Video Chat Connection System

1. Mainframe/Server that hosts game programming and allows players to log in and stream their images and sound live into a videochat room. Game programming may also be downloaded and operated from player systems such as, but not limited to, PCs, Laptops, Cell Phones, TVs, PDAs, Game systems, etc. All players are then formatted using game programming to direct player's screens in synchronized ways so that all players experience game events simultaneously.

2. Player 1 connects to any number of videochatters using his local computerized system through the internet to a server/mainframe. In this example, Player 1 is connecting and streaming his live image and sound to Player 2, and Player 1 is receiving game data and streaming images of other players (Player 2 is shown in this example).

3. Player 2 experiences the system simultaneously the way player 1 does. This is true for any and all numbers of players that are connected to the system.

### Additional Embodiments

1. This system can be displayed on any electronic device meant for display. Some examples are, but not limited to, television, Computer monitors, PDAs, etc.

2. This system is offered through computerized devices such as, but not limited to, televisions, high speed cable systems, video game systems, computers, PDAs, cell phones, etc.

3. This system can be used to deliver real-time advertising to online videoconferencing games and game observers, who would then be able to take advantage of clickable, limited time advertising.

4. Adult games might be offered with a player acting as an administrator to make sure players are kept safe. A software system might be offered where one player of each virtual conference room acts as an administrator who would be able to mediate disputes, eject unruly or offensive players, or flag players that have consumed too much alcohol.

5. A game like “hide and seek” might also be played where a player sets a timer on the graphic game display. This timer turns off the visual and audio feeds from that player's system for a limited amount of time while that player hides (in an area visible by their video capture hardware of course), then when time expires, their feeds are switched back on by the system and players yell out where the player might be hiding.

6. Game types could be restricted to certain age groups, as verified through adult age verification websites, and also can be monitored by room administrators.

7. Offensive players that have been ejected from rooms could be given their own virtual rooms where they can be belligerent together, and their antics might be more appreciated.

8. Warnings could be provided, and care should be taken, to remove all personal contact information from areas broadcast out to conferences.

9. Players could be given the opportunity to click a “create a private room” link that would take the player to a private room that they might then send out invitations for others to join them. Invitations might take the form of, but not limited to, text messages, IMs, email, and/or Skype calls.

10. A system purchased on the open market might provide a product that could be employed to collect and distribute wages placed on games.

11. A system purchased on the open market might be employed to provide auction capabilities to sell items that celebrities used during game play.

12. A voting system could be employed to rate players and used to generate player fame and party room popularity

13. A player's vital statistics could be collected at time of account creation. One such statistic might be a player's weight that could be used to generate alcohol consumption warnings as the system could track how many drinks a player consumes over a certain time period.

14. Virtual conference rooms might carry themes such as “the Bud drinkers club” where players enter and only consume Budweiser beer, giving them a common ground for interaction and communication.

Players may choose to name their own virtual conference rooms to create an identity for their group, and so that others may find them.

15. A graphic representation of a city might be offered that allows players to select and name a virtual building for their party house (another name for a videoconference room). Players might click on a specific house and enter to watch currently running parties, or see a schedule of when players are typically active in these rooms.

16. Graphic virtual buildings might be sold to players based on the building's appearance, and a player might also purchase a specific location to either house their room, or place their purchased building.

17. Players that create their own rooms might also have the ability to send out invitations in the forms listed in 9

18. Invitations might also be sent out by players looking to fill empty party seats in their rooms.

19. Internet dating sites, as well as real world dating companies, and/or dating organizations, could use this service to group potential matches together to let them interact through social games to see if sparks fly. Multiple potential mates could be experienced all at the same time and one could pick the individual they like best.

20. This patent could allow the quiet playing of games in dorm rooms where parties are not permitted, as players don't need to cross long distance to be together, it could just be 5 consecutive rooms in a dorm getting together to have fun.

21. Point and click selection of players. Depending on the game being played, a player may click another player's image to queue them and let them know play has been passed to them.

22. Translation software may be employed to help players with dissimilar language preferences communicate during game play.

1. Web-based games are created using the visual and/or audio stimuli of videoconference attendees, a coded sequence of events that direct game play, manipulation of camera effects, display of text-based data, background geometric shapes and colors, and the manipulation of player(s) displayed images.

2. As per 1, a player's image may be manipulated through changes in size, shape, on-screen positioning, or frame color.

3. As per 1, instead of a player providing live streaming images, a pre-recorded representation of a player providing game stimuli may be presented to further game play.

4. As per 1, a coded process may be included within the videoconference game that manipulates the positioning, color, and size of player images in a systematic process resulting in a game function or format.

5. As per 1, text-based data may be displayed as stimuli to move the game forward
